(19) United States
(12) Patent Application Publication
(10) Pub. No.: US 2011/0129710 A1
(43) Pub. Date: Jun. 2, 2011

(54) WOUND ELECTROCHEMICAL DEVICE AND MANUFACTURING METHOD THEREOF

(75) Inventors: Yoshihiko OHASHI, Tokyo (JP); Akio YAMANAKA, Tokyo (JP); Yukio SHINOHARA, Tokyo (JP); Yuriko AKIMOTO, Tokyo (JP); Kazue HASEGAWA, Tokyo (JP)

(73) Assignee: TDK CORPORATION, Tokyo (JP)

(21) Appl. No.: 12/951,519

(22) Filed: Nov. 22, 2010

(30) Foreign Application Priority Data
Nov. 27, 2009 (JP) P2009-270564
Nov. 27, 2009 (JP) P2009-270566

(51) Int. Cl. H01M 10/02; H01M 10/0587; H01G 9/00

(52) U.S. Cl. 429/94; 29/623.1; 29/623.5; 361/500

(57) ABSTRACT

A resin layer RN is bonded to a corner of the other end of at least one of an anode electrode A and a cathode electrode K and an outer edge of a corner of the other end of the other of the anode electrode A and the cathode electrode K is not located on a straight line passing an outer edge of the corner of the other end of the at least one and being parallel to a thickness direction of the electrode. In another embodiment, an outer edge of a corner of the other end of at least one of the anode electrode A and the cathode electrode K consists of an arcuate curve when viewed from a direction parallel to the thickness direction thereof, and an outer edge of a corner of the other end of the other of the anode electrode A and the cathode electrode K is not located on a straight line passing the outer edge of the corner of the other end of the at least one and being parallel to the thickness direction.

### BACKGROUND OF THE INVENTION

1. Field of the Invention

The present invention relates to a wound electrochemical device and a method for manufacturing the same.

2. Related Background Art

A conventional electrochemical device has a structure in which a battery element such as a lithium-ion battery (LIB) or an electric double layer capacitor (EDLC) is enclosed in an outer package comprised of aluminum, and further improvement is recently expected in characteristics of the electrochemical device of a wound type. Such a wound electrochemical device is described, for example, in Patent Literature 1. This wound electrochemical device is made by superimposing one end of a beltlike anode electrode and one end of a beltlike cathode electrode on each other with a separator in between so as to make their respective width directions coincident with each other, defining the width directions as an axis, and winding the anode electrode and the cathode electrode with the separator in between around the axis in an identical direction.

### Prior Technical Literature

### Patent Literature

Patent Literature 1: Japanese Patent Application Laid-open No. 2002-217075

### SUMMARY OF THE INVENTION

However, the inventors conducted diligent research on the conventional wound electrochemical device and found the problem of gradual reduction in voltage between terminals with a lapse of time in the conventional wound electrochemical device, though the cause thereof was unknown.

The present invention has been accomplished in view of the above problem and it is an object of the present invention to provide a wound electrochemical device improved in a voltage holding property and a method for manufacturing the same.

The inventors conducted further detailed research on the cause to deteriorate the voltage holding property of the conventional wound electrochemical device and discovered that a leak current flowed from corners of the electrode at a winding end position toward the electrode of the other polarity opposed thereto.

Specifically, a wound electrochemical device according to the present invention is a wound electrochemical device configured by superimposing one end of a beltlike anode electrode and one end of a beltlike cathode electrode on each other with a separator in between so as to make their respective width directions coincident with each other, defining the width directions as an axis, and winding the anode electrode and the cathode electrode with the separator in between around the axis in an identical direction, wherein an outer edge of a corner of the other end of at least one of the anode electrode and the cathode electrode consists of an arcuate curve when viewed from a direction parallel to a thickness direction thereof, and wherein an outer edge of a corner of the other end of the other of the anode electrode and the cathode electrode is not located on a straight line passing the outer edge of the corner of the other end of the at least one and being parallel to the thickness direction.

In the wound electrochemical device of the present invention, the corner at the winding end position of the electrode (corner of the other end) is provided with the curvature (arcuate curve) and in this case, we found that the voltage holding property was remarkably improved. Furthermore, this position of the electrode is different from the position of the corner in the other polarity opposed thereto, which also provides an advantage of producing no leak current between the corners of the different polarities.

The wound electrochemical device of the present invention preferably satisfies the following relational expression: 02 (mm)≦R (mm)≦W (mm)/3, where W (mm) is a width of the electrode providing the arcuate curve and R (mm) a radius of curvature of the curve. In this case, the voltage holding property becomes very good.

A manufacturing method of a wound electrochemical device according to the present invention is a method for manufacturing a wound electrochemical device, comprising: (1) a step of preparing a beltlike anode electrode and a beltlike cathode electrode; (2) a step of superimposing one end of the beltlike anode electrode and one end of the beltlike cathode electrode on each other with a separator in between so as to make their respective width directions coincident with each other; and (3) a step of defining the width directions as an axis and winding the anode electrode and the cathode electrode with the separator in between around the axis in an identical direction, the method further comprising (4) a step of processing a corner of the other end of at least one of the anode electrode and the cathode electrode, the step comprising such processing that an outer edge of the corner consists of an arcuate curve when viewed from a direction parallel to a thickness direction thereof, the method comprising (5) such setting that an outer edge of a corner of the other end of the other of the anode electrode and the cathode electrode is not located on a straight line passing the outer edge of the corner of the other end of the at least one and being parallel to the thickness direction.

When this manufacturing method is applied, the electrochemical device can be manufactured with remarkable improvement in the voltage holding property as described above. Preferably, in the step of processing the corner, the corner formed by this step satisfies the following relational expression: 0.2 (mm)≦R (mm)≦W (mm)/3, where W (mm) is a width of the electrode providing the arcuate curve and R (mm) a radius of curvature of the curve. In this case, the device can be manufactured with the voltage holding property being extremely excellent.

Another wound electrochemical device according to the present invention is a wound electrochemical device configured by superimposing one end of a beltlike anode electrode and one end of a beltlike cathode electrode on each other with a separator in between so as to make their respective width directions coincident with each other, defining the width directions as an axis, and winding the anode electrode and the cathode electrode with the separator in between around the axis in an identical direction, wherein a resin layer is bonded to a corner of the other end of at least one of the anode electrode and the cathode electrode, and wherein an outer edge of a corner of the other end of the other of the anode electrode and the cathode electrode is not located on a straight line passing an outer edge of the corner of the other end of the at least one and being parallel to a thickness direction thereof.

In the wound electrochemical device of the present invention, the corner at the winding end position of the electrode (corner of the other end) is provided with the resin layer, and in this case, the inventors found that the voltage holding property was remarkably improved. Furthermore, this position of the electrode is different from the position of the corner in the other polarity opposed thereto, which also provides the advantage of producing no leak current between the corners of the different polarities.

A thickness of the resin layer is preferably not less than 10 μm and not more than 100 μm. In this case, the voltage holding property becomes very good.

Preferably, the resin layer bonded to the corner is also bonded to the separator adjacent thereto. In this case, the resin layer can secure the electrode and the separator.

Preferably, the resin layer contains polyvinylidene fluoride. When polyvinylidene fluoride is used, the resin layer has high heat resistance and provides an effect to avoid deterioration of the resin layer even if the electrochemical device becomes hot during operation thereof.

Another manufacturing method of a wound electrochemical device according to the present invention is a method for manufacturing a wound electrochemical device, comprising: (1) a step of preparing a beltlike anode electrode and a beltlike cathode electrode; (2) a step of superimposing one end of the beltlike anode electrode and one end of the beltlike cathode electrode on each other with a separator in between so as to make their respective width directions coincident with each other; and (3) a step of defining the width directions as an axis and winding the anode electrode and the cathode electrode with the separator in between around the axis in an identical direction, the method further comprising (4) a step of bonding a resin layer to a corner of the other end of at least one of the anode electrode and the cathode electrode, the method comprising (5) such setting that an outer edge of a corner of the other end of the other of the anode electrode and the cathode electrode is not located on a straight line passing an outer edge of the corner of the other end of the at least one and being parallel to a thickness direction thereof.

When this manufacturing method is applied, the electrochemical device can be manufactured with remarkable improvement in the voltage holding property as described above.

In the manufacturing method of the present invention, a thickness of the resin layer is also preferably not less than 10 μm and not more than 100 μm. In this case, the device can be manufactured with the voltage holding property being extremely excellent.

Preferably, the step of bonding the resin layer to the corner comprises: a step of applying a solution obtained by dissolving a resin material in a solvent, onto the corner; and a step of drying the solution after applied. In this case, it is feasible to suppress burrs at the corner. The separator becomes less likely to be broken by the corner and even if the separator is broken, the resin layer brings about an effect to prevent a short.

Preferably, the resin material contains polyvinylidene fluoride, and the solvent contains N-methylpyrrolidone. In this case, the method provides an effect to readily form a film for prevention of a short.

The present invention provides the wound electrochemical devices improved in the voltage holding property.

### BRIEF DESCRIPTION OF THE DRAWINGS

FIG. 1 is a perspective view of a wound electrochemical device (without illustration of an outer package) according to an embodiment

FIG. 2 is a cross-sectional view of the wound electrochemical device shown in FIG. 1, along a line and in a direction of arrows II-II.

FIG. 3 is an enlarged cross-sectional view of region III shown in FIG. 2.

FIG. 4 is a plan view of a tip portion of a beltlike electrode.

FIG. 5 is a plan view of beltlike electrodes and separator.

FIG. 6 is an explanatory drawing for explaining a manufacturing method of the wound electrochemical device.

FIG. 7 is side views showing multilayer structures of an anode electrode and a cathode electrode.

FIG. 8 is a perspective view of a wound electrochemical device (without illustration of an outer package) according to another embodiment.

FIG. 9 is a cross-sectional view of the wound electrochemical device shown in FIG. 8, along a line and in a direction of arrows II-II.

FIG. 10 is an enlarged cross-sectional view of region III shown in FIG. 9.

FIG. 11 is a plan view of a tip portion of a beltlike electrode.

FIG. 12 is a plan view of beltlike electrodes and separator.

FIG. 13 is an explanatory drawing for explaining a manufacturing method of the wound electrochemical device.

FIG. 14 is side views showing multilayer structures of an anode electrode and a cathode electrode.

### DESCRIPTION OF THE PREFERRED EMBODIMENTS

The preferred embodiments of the present invention will be described below in detail with reference to the accompanying drawings. In the description of the drawings, identical or equivalent elements will be denoted by the same reference signs, without redundant description. The below will describe the electrochemical devices of the first category and the second category. The electrochemical device of the first category will be first described.

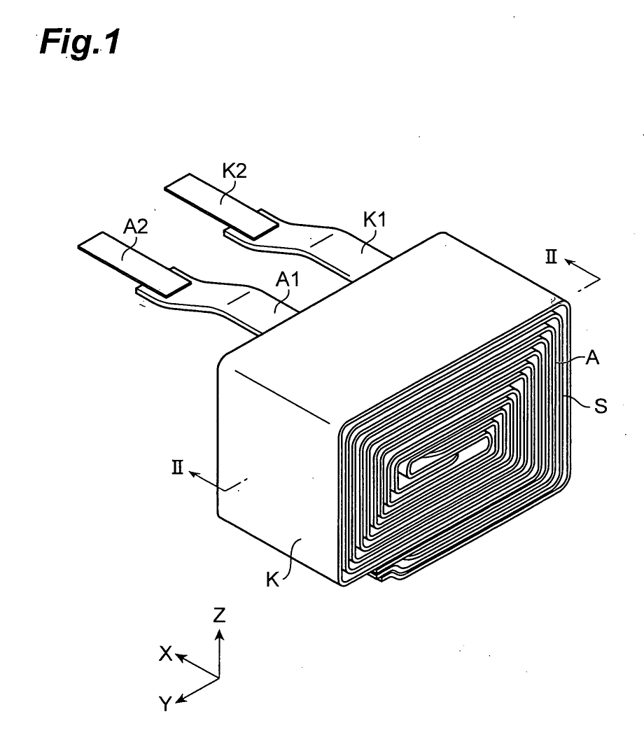

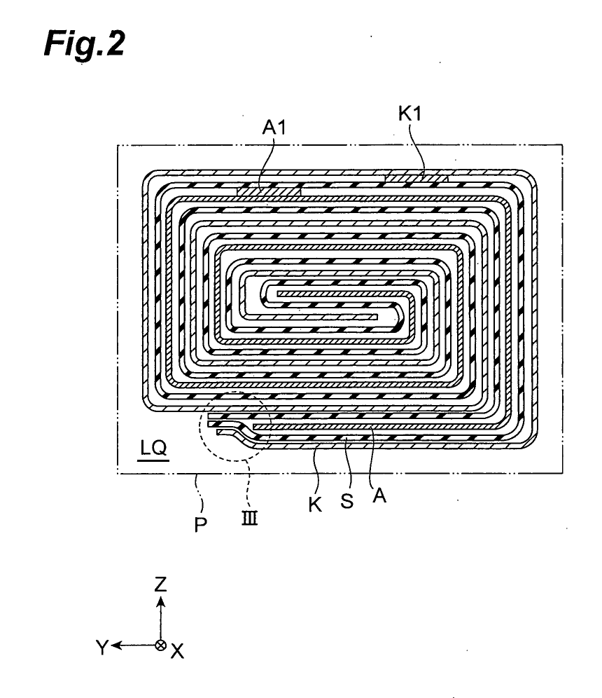

FIG. 1 is a perspective view of the wound electrochemical device (without illustration of an outer package) according to an embodiment, and FIG. 2 is a cross-sectional view of the wound electrochemical device shown in FIG. 1, along a line and in a direction of arrows II-II. In the drawings there is an XYZ three-dimensional orthogonal coordinate system shown.

This wound electrochemical device has a beltlike anode electrode A, a beltlike cathode electrode K, and a beltlike separator S in an outer package P (cf. FIG. 2). The separator S is interposed between the anode electrode A and the cathode electrode K and these are wound around the X-axis. The X-axis is coincident with width directions of the beltlike anode electrode A, cathode electrode K, and separator S. The Z-axis direction in FIG. 2 is a thickness direction of portions extending along the Y-axis direction, of the anode electrode A, cathode electrode K, and separator S, but is a length direction of portions thereof extending along the Z-axis direction.

The anode electrode A, cathode electrode K, and separator S are wound in one direction. When the winding start position is defined at one ends of the anode electrode A and cathode electrode K, the one ends are located near the center of the electrochemical device. When the winding end position is defined at the other ends of the anode electrode A and cathode electrode K, the other ends are located in outside layers of the electrochemical device.

An electrolytic solution LQ is retained inside the outer package P as needed. The electrolytic solution LQ to be used herein is one obtained by dissolving an electrolyte in an organic solvent. The electrolyte used generally is a quaternary ammonium salt such as tetraethylammonium tetrafluoroborate (TEA⁺BF₄⁻: (which will be referred to hereinafter as TEA-BF4)) or triethyl monomethyl ammonium tetrafluoroborate (TEMA⁺BF₄⁻). These electrolytes may be used singly or in combination of two or more. The organic solvent applicable herein is one of the known solvents. Preferred examples of the organic solvent include propylene carbonate, ethylene carbonate, diethyl carbonate, and so on. These may be used singly or in a mixture of two or more at an optional ratio.

As described above, this wound electrochemical device is a wound electrochemical device configured by superimposing one end of the beltlike anode electrode A and one end of the beltlike cathode electrode K on each other with the separator S in between so as to make their respective width directions (X-axis) coincident with each other, defining the width directions as an axis (X-axis), and winding the anode electrode A and the cathode electrode K with the separator S in between around the axis in the same direction.

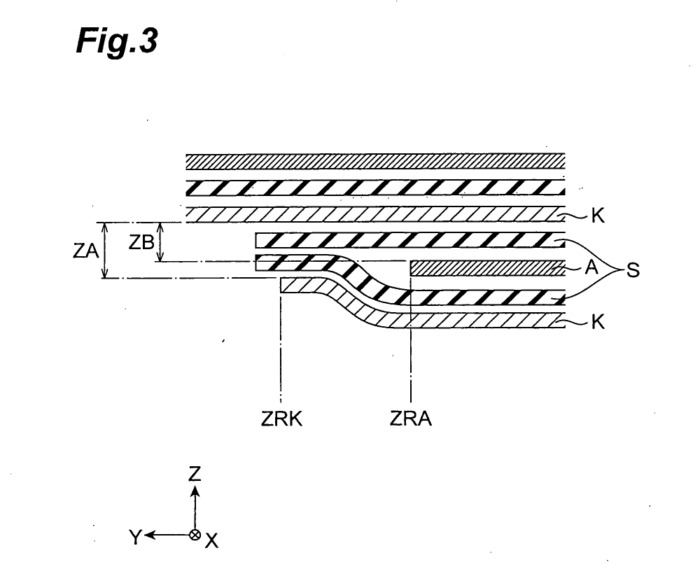

FIG. 3 is an enlarged cross-sectional view of region III shown in FIG. 2, and shows the region near the winding end positions of the anode electrode A and the cathode electrode K.

Near the winding end positions, the anode electrode A and the cathode electrode K have their respective other ends. Let ZRA be the position of the other end along the length direction of the anode electrode A, and ZRK be the position of the other end along the length direction of the cathode electrode K. The distance of separation along the length direction (Y-axis) between these positions ZRA and ZRK is preferably as long as possible. The reason is that an electric current is likely to leak at the ends and if those locations are close to each other, an electric current will actually leak significantly.

ZA refers to a minimum distance of separation in the thickness direction (Z-axis direction) between the electrode of one polarity (cathode electrode K) and the electrode of the same polarity (cathode electrode K) at the position of the other end (ZRK). Furthermore, ZB refers to a minimum distance of separation in the thickness direction (Z-axis direction) between the electrode of one polarity (anode electrode A) and the electrode of the other polarity (cathode electrode K) at the position of the other end (ZRA). Since the cathode electrode K is opposed through two or more layers of separator S and to the cathode electrode K of the same polarity, an electric leak is unlikely to occur between these. On the other hand, since the other end of the anode electrode A is opposed to the cathode electrode K of the different polarity through one layer of separator S, electric coupling is likely to occur between these and an electric leak can occur (ZA>ZB). Therefore, the plane shape of the electrode is processed into a shape to suppress the electric leak at the other end of the anode electrode A. The anode electrode A and the cathode electrode K are replaceable with each other in terms of position and shape, and the processing of the shape of the anode electrode A can also be applied to the cathode electrode.

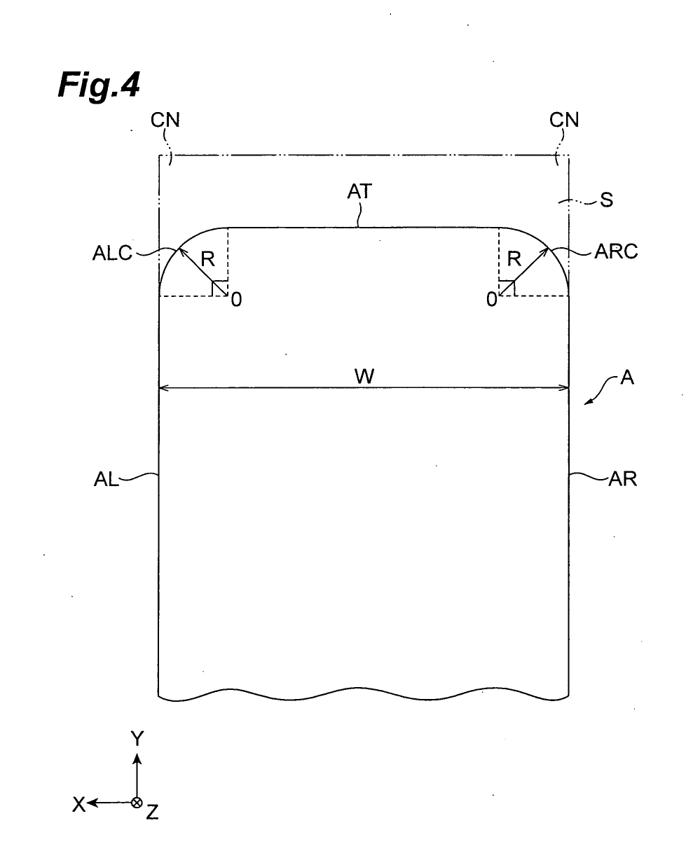

FIG. 4 is a plan view of a tip portion of the beltlike anode electrode A.

An outer edge of each corner of the other end of the anode electrode A consists of an arcuate curve ALC, ARC when viewed from a direction parallel to the thickness direction (Z-axis) thereof. An outer edge of the corners of the other end of the other, the cathode electrode K, is not located on a straight line passing the outer edge of these corners (curves ALC, ARC) and being parallel to the thickness direction (Z-axis) of the corners (in other words, ZRA and ZRK do not coincide in FIG. 2).

In this wound electrochemical device, the corners at the winding end position of the anode electrode A (the corners of the other end thereof) are provided with the respective curvatures (arcuate curves ALC, ARC), and in this case, we found that the voltage holding property was remarkably improved. A conceivable reason for it is that the degree of sharpening of the electrode is relaxed so as to relieve concentration of electric field and thereby suppress the electric leak. Furthermore, this position of the anode electrode A is different from the position of the corners in the cathode electrode K opposed thereto (it is opposed to a flat portion of the cathode electrode), and this also provides an advantage of producing no leak current between the corners of the different polarities.

The wound electrochemical device preferably satisfies the following relational expression:

0.2 (mm)≦R (mm)≦W (mm)/3,

where W (mm) is the width of the electrode providing the arcuate curves (ALC, ARC) (distance between side AL and side AR) and R (mm) the radius of curvature of the curves. In this case, the voltage holding property becomes very good.

The length of the separator S is larger than that of the anode electrode A and the tip portion of the separator S is projecting forward (in the positive direction of the Y-axis) from the side AT located at the leading end of the anode electrode A. A pair of sides AL, AR perpendicular to the width direction of the anode electrode A are parallel and these are 90° different in extending direction from the side AT at the leading end. Therefore, this configuration can prevent a leak current from flowing around the separator S between the anode electrode A and the cathode electrode K opposed thereto. Concerning the outer edge shape of the anode electrode A, the pair of sides AL and AR extending left and right are parallel to each other, and the side AT is perpendicular to them. The tip portion of the separator S consists of two sides parallel to the length direction, and a side at the leading end perpendicular thereto, and has two corners CN. These corners CN are right-angled.

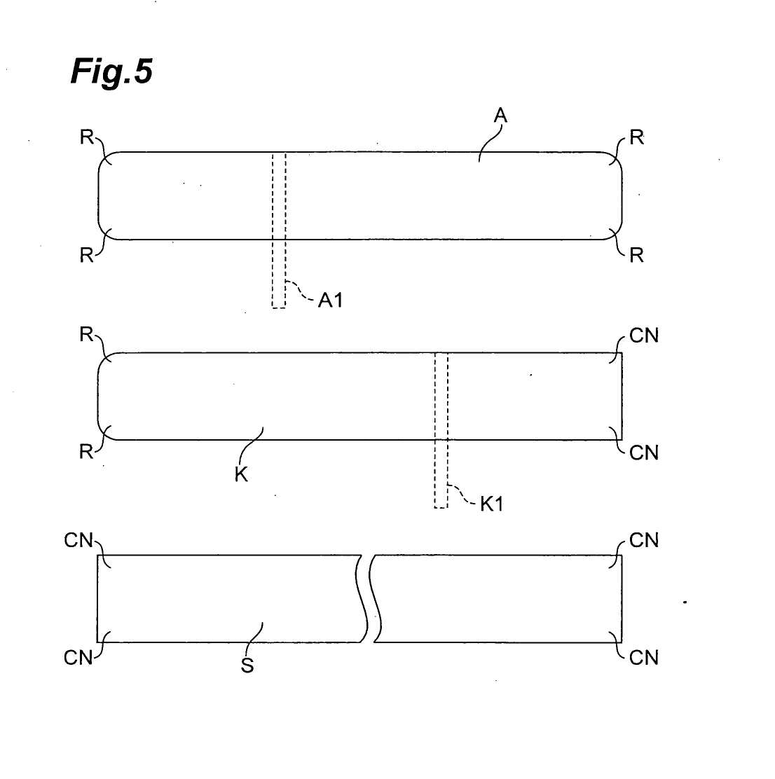

FIG. 5 is a plan view of the beltlike electrodes and separator.

The anode electrode A is the beltlike electrode and has four corners, and in the present embodiment all the corners are provided with curvatures. A tab (lead) A1 is attached at the position of about ⅔ of the length from the right end of the anode electrode A. Similarly, the cathode electrode K is the beltlike electrode and has four corners, and in the present embodiment two corners are provided with curvatures and the remaining two corners are right-angled. This is because it is considered that even if an electric field is concentrated at such portions of the cathode electrode, the electric leakage is unlikely to occur because the distance is long to the anode electrode adjacent in the thickness direction. A tab (lead) K1 is attached at the position of about ⅔ of the length from the left end of the cathode electrode K. The separator S has its ends without curvature and thus the four corners all are right-angled.

A method for manufacturing the wound electrochemical device will be described below.

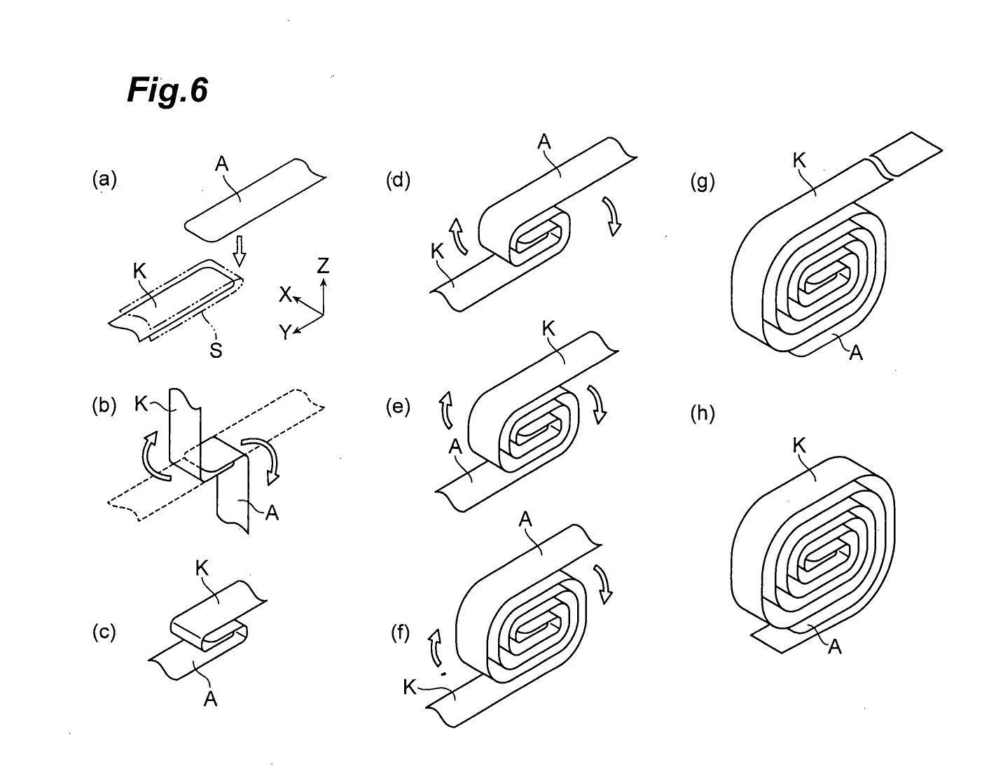

FIG. 6 is an explanatory drawing for explaining the method for manufacturing the wound electrochemical device.

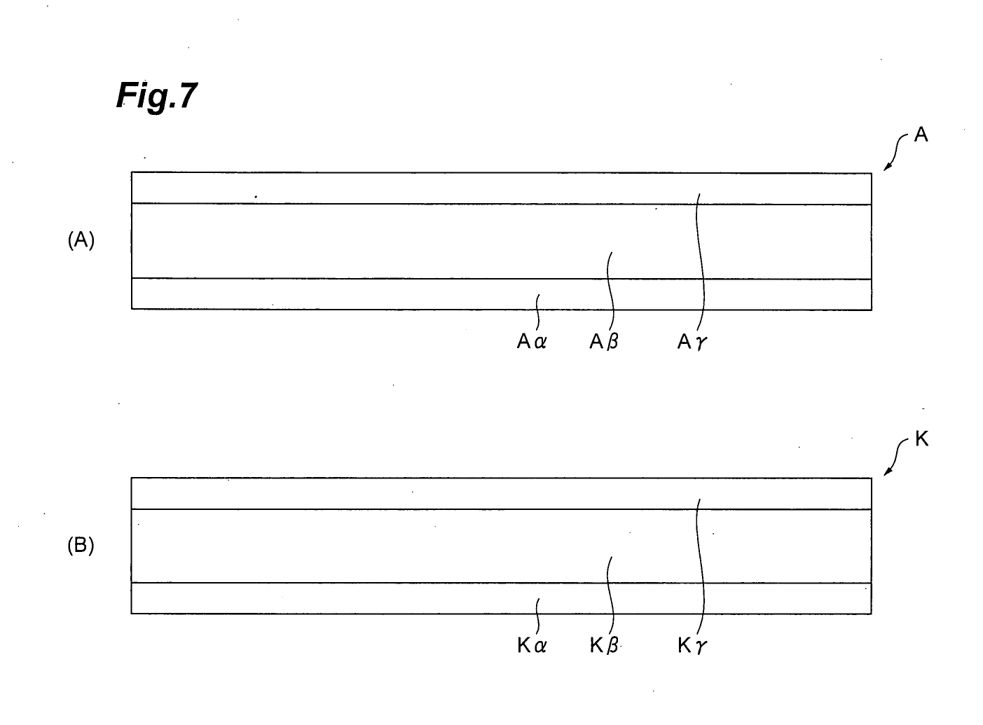

In the manufacturing method of the wound electrochemical device, the first step is to prepare the beltlike anode electrode A and the beltlike cathode electrode K. Specific structures of the anode electrode A and the cathode electrode K are, for example, as shown in FIG. 7. The next step is as shown in FIG. 6(a), to superimpose one end of the beltlike anode electrode A and one end of the beltlike cathode electrode K on each other with the separator S in between so as to make their respective width directions coincident with each other. The separator S is folded into two and then the cathode electrode K is inserted into between the folded portions. Although the separator S is still present in the subsequent steps, the illustration of the separator S is omitted in the drawing after FIG. 6(b), for clarity of the description on the drawing. In the superposition of the one ends, because the anode electrode A and the cathode electrode K are provided similarly with the curvatures at their one ends, the electric leakage is also prevented at such locations.

Next, as shown in FIG. 6(b) to FIG. 6(h), the anode electrode A and the cathode electrode K are bent in directions of arrows. Namely, as the width directions (X-axis) of these are defined as an axis, the anode electrode A and cathode electrode K are wound with the separator S in between around the axis in the same direction. The lengths of the anode electrode A and cathode electrode are so set that at the final stage after they are wound as shown in the same drawing, the outer edge (position ZRK) of the corners of the other end of one of the anode electrode A and the cathode electrode K is not located on a straight line (position ZRA) passing the outer edge of the corners of the other end of the other and being parallel to the thickness direction thereof, as shown in FIG. 3.

Before the winding step, the corners of the other end of at least one of the anode electrode A and the cathode electrode K are processed into curved shape, as shown in FIG. 5. Specifically, the outer edge of each corner is processed so that it consists of an arcuate curve, when viewed from a direction parallel to the thickness direction thereof. This processing can be performed with a shearing machine or with a blade.

When the above-described manufacturing method is applied, the electrochemical device can be manufactured with remarkable improvement in the voltage holding property.

FIG. 7 is side views showing multilayer structures of the anode electrode and cathode electrode.

The anode electrode A has a beltlike collector Aβ, and positive-electrode active material layers Aα, Aγ formed on the front surface and back surface of the collector Aβ. The cathode electrode K has a beltlike collector Kβ, and negative-electrode active material layers Kα, Kγ formed on the front surface and back surface of the collector Kβ. The collectors are generally made of copper or aluminum and the thickness thereof is, for example, about 10-50 μm. The collectors Aβ, Kβ are equipped with respective tab electrodes A1, K1 as shown in FIG. 1 and leads A2, K2 are connected to respective tips of the tab electrodes A1, K1. The leads A2, K2 are exposed in part to the outside of the outer package P (cf. FIG. 2).

The positive-electrode active material layers Aα, Aγ and the negative-electrode active material layers Kα, Kγ contain an active material and a binder and preferably contain an electroconductive aid.

The active material may be one of various porous materials with electron conductivity, e.g., carbon materials such as natural graphite, synthetic graphite, mesocarbon microbeads, mesocarbon fiber (MCF), coke, glassy carbon, a baked product of an organic compound, and so on. There are no particular restrictions on the binder as long as it can fix the foregoing active material and, preferably, the electroconductive aid to the collectors; it can be selected from a variety of binding agents.

Examples of the binder include fluorine resins such as polyvinylidene fluoride (PVDF) and polytetrafluoroethylene (PTFE), mixtures of styrene-butadiene rubber (SBR) and water-soluble polymers (carboxymethyl cellulose, polyvinyl alcohol, sodium polyacrylate, dextrin, gluten, etc.), and so on.

The electroconductive aid is a material that is added in order to enhance the electron conductivity of the positive-electrode active material layers and the negative-electrode active material layers. Examples of the electroconductive aid include carbon materials such as carbon black and acetylene black, fine powders of metal such as copper, nickel, stainless steel, or iron, mixtures of the carbon materials and the fine metal powders, and electroconductive oxides such as ITO.

The thickness of the positive-electrode active material layers Aα, Aγ and the negative-electrode active material layers Kα, Kγ is, for example, about 1-200 μm. The positive-electrode active material layers and the negative-electrode active material layers are formed on the respective collectors so as to avoid the tab for connection to the lead. The positive-electrode active material layers and the negative-electrode active material layers can be made by one of the known methods.

The separator S is an element for electrically isolating the anode electrode A and the cathode electrode K from each other, and is an electrically insulating porous body. There are no particular restrictions on the separator S and the separator S can be selected from a variety of separator materials. For example, the electrically insulating porous body can be a single-layer body or multilayer body of film comprised of polyethylene, polypropylene, or polyolefin, a stretched film of a mixture of the foregoing resins, or a nonwoven fabric of fiber comprised of at least one constituent material selected from the group consisting of cellulose, polyester, and polypropylene. The thickness of the separator S is, for example, about 5-50 μm.

Next, experiments to produce the above-described electrochemical device experimentally were conducted.

### Experiment Examples

Experiments were carried out as to the electrochemical device of the first category. The wound electrochemical device (EDLC) was produced in the following manner. The number of turns of the anode electrode was 6. Common conditions are as described below. The activated carbon used as the active material was activated carbon (RP-20) available from KURARAY CHEMICAL CO., LTD.
Anode electrode
   dimensions:
      width W=12.5 mm
      thickness 57 μm
      length=95 mm
   materials;
      collector: aluminum
      active material: activated carbon
Cathode electrode
   dimensions:
      width W=12.5 mm
      thickness=57 μm
      length=117 mm
   materials:
      collector: aluminum
      active material: activated carbon
Separator
   dimensions:
      width W=14.5 mm
      thickness=30 μm
      length=197 mm
   material:
      cellulose
Electrolytic solution
   material: TEA-BF4
Tab material: aluminum
Lead material: aluminum
Deviation between electrodes (distance between position ZRA and position ZRK) 5 mm

As shown in FIG. 5, after the cathode electrode K was wound, the outermost end thereof had the right-angled corners CN, and this is defined as type A. Type B is defined as one with a curvature at the position of the other end of the cathode electrode K as well as on the one end side.

### (Evaluations and Results)

The evaluations and results of Examples and Comparative Examples of the first category will be presented below.

The evaluations were carried out as follows: at room temperature, the voltage of 2.5 V was applied between the anode electrode and the cathode electrode of the electrochemical device, the device was charged for one hour, a charger was then taken out, the device was left for two hours, and the capacitance (mF) and voltage (V) between these electrodes were measured. Tables below provide the radius of curvature R, the type of the electrode shape, the capacitance (mF) of each measured electrochemical device, the voltage measured (V), and judgment results of these capacitance and voltage. The judgment of capacitance was made according to the following criteria: a sample with the capacitance of not less than 1100 mF was defined as nondefective (◯) and a sample with the capacitance of not less than 1000 mF was defined as acceptable (Δ). The judgment of voltage was made according to the following criteria: a sample with the voltage of not less than 2.2 V was defined as nondefective (◯), a sample with the voltage of not less than 2.0 V as acceptable (Δ), and a sample with the voltage of less than 2.0 V as defective (×). R=0 mm indicates samples of Comparative Examples, which are samples in which the other end of the anode electrode located outermost is not provided with a curvature. It is noted concerning the experiments below that the same results must be obtained even with replacement of the anode electrode and the cathode electrode with each other.

TABLE 1

| | | | | | Judgment | |
|---|---|---|---|---|---|---|
| | R | | Capacitance | Voltage | Capac- | Volt- |
| | (mm) | Type | (mF) | (V) | itance | age |
| Example l | 3.0 | A | 1201 | 2.31 | ◯ | ◯ |
| Example 2 | 3.0 | A | 1209 | 2.32 | ◯ | ◯ |
| Example 3 | 3.0 | A | 1214 | 2.33 | ◯ | ◯ |
| Example 4 | 3.0 | A | 1204 | 2.34 | ◯ | ◯ |
| Example 5 | 3.0 | A | 1212 | 2.31 | ◯ | ◯ |
| Example 6 | 3.0 | A | 1211 | 2.32 | ◯ | ◯ |
| Example 7 | 3.0 | A | 1209 | 2.30 | ◯ | ◯ |
| Example 8 | 3.0 | A | 1210 | 2.33 | ◯ | ◯ |
| Example 9 | 3.0 | A | 1212 | 2.31 | ◯ | ◯ |
| Example 10 | 3.0 | A | 1200 | 2.33 | ◯ | ◯ |

TABLE 2

| | | | | | Judgement | |
|---|---|---|---|---|---|---|
| | R | | Capacitance | Voltage | Capac- | Volt- |
| | (mm) | Type | (mF) | (V) | itance | age |
| Example 11 | 0.3 | A | 1203 | 2.21 | ◯ | ◯ |
| Example 12 | 0.3 | A | 1208 | 2.21 | ◯ | ◯ |
| Example 13 | 0.3 | A | 1201 | 2.22 | ◯ | ◯ |
| Example 14 | 0.3 | A | 1215 | 2.25 | ◯ | ◯ |
| Example 15 | 0.3 | A | 1201 | 2.23 | ◯ | ◯ |
| Example 16 | 0.3 | A | 1210 | 2.24 | ◯ | ◯ |
| Example 17 | 0.3 | A | 1211 | 2.22 | ◯ | ◯ |
| Example 18 | 0.3 | A | 1204 | 2.21 | ◯ | ◯ |
| Example 19 | 0.3 | A | 1213 | 2.20 | ◯ | ◯ |
| Example 20 | 0.3 | A | 1207 | 2.22 | ◯ | ◯ |

TABLE 3

| | | | Capacitance | Voltage | Judgment | |
|---|---|---|---|---|---|---|
| | R (mm) | Type | (mF) | (V) | Capacitance | Voltage |
| Example21 | 4.1 | A | 1150 | 2.32 | ◯ | ◯ |
| Example22 | 4.1 | A | 1117 | 2.31 | ◯ | ◯ |
| Example23 | 4.1 | A | 1178 | 2.32 | ◯ | ◯ |
| Example24 | 4.1 | A | 1147 | 2.33 | ◯ | ◯ |
| Example25 | 4.1 | A | 1111 | 2.31 | ◯ | ◯ |
| Example26 | 4.1 | A | 1167 | 2.31 | ◯ | ◯ |
| Example27 | 4.1 | A | 1164 | 2.30 | ◯ | ◯ |
| Example28 | 4.1 | A | 1136 | 2.32 | ◯ | ◯ |
| Example29 | 4.1 | A | 1131 | 2.31 | ◯ | ◯ |
| Example30 | 4.1 | A | 1136 | 2.33 | ◯ | ◯ |

TABLE 4

| | | | Capacitance | Voltage | Judgment | |
|---|---|---|---|---|---|---|
| | R (mm) | Type | (mF) | (V) | Capacitance | Voltage |
| Example31 | 0.1 | A | 1212 | 2.00 | ◯ | Δ |
| Example32 | 0.1 | A | 1208 | 2.10 | ◯ | Δ |
| Example33 | 0.1 | A | 1211 | 2.11 | ◯ | Δ |
| Example34 | 0.1 | A | 1211 | 2.02 | ◯ | Δ |
| Example35 | 0.1 | A | 1203 | 2.01 | ◯ | Δ |
| Example36 | 0.1 | A | 1209 | 2.07 | ◯ | Δ |
| Example37 | 0.1 | A | 1208 | 2.07 | ◯ | Δ |
| Example38 | 0.1 | A | 1202 | 2.02 | ◯ | Δ |
| Example39 | 0.1 | A | 1210 | 2.03 | ◯ | Δ |
| Example40 | 0.1 | A | 1212 | 2.10 | ◯ | Δ |

TABLE 5

| | | | Capacitance | Voltage | Judgment | |
|---|---|---|---|---|---|---|
| | R (mm) | Type | (mF) | (V) | Capacitance | Voltage |
| Example41 | 4.5 | A | 1084 | 2.30 | Δ | ◯ |
| Example42 | 4.5 | A | 1072 | 2.31 | Δ | ◯ |
| Example43 | 4.5 | A | 1043 | 2.32 | Δ | ◯ |
| Example44 | 4.5 | A | 1068 | 2.32 | Δ | ◯ |
| Example45 | 4.5 | A | 1067 | 2.33 | Δ | ◯ |
| Example46 | 4.5 | A | 1082 | 2.31 | Δ | ◯ |
| Example47 | 4.5 | A | 1052 | 2.31 | Δ | ◯ |
| Example48 | 4.5 | A | 1060 | 2.31 | Δ | ◯ |
| Example49 | 4.5 | A | 1067 | 2.30 | Δ | ◯ |
| Example50 | 4.5 | A | 1088 | 2.31 | Δ | ◯ |

TABLE 6

| | | | Capacitance | Voltage | Judgment | |
|---|---|---|---|---|---|---|
| | R (mm) | Type | (mF) | (V) | Capacitance | Voltage |
| Example51 | 3.0 | B | 1205 | 2.13 | ◯ | Δ |
| Example52 | 3.0 | B | 1208 | 2.10 | ◯ | Δ |
| Example53 | 3.0 | B | 1201 | 2.05 | ◯ | Δ |
| Example54 | 3.0 | B | 1203 | 2.06 | ◯ | Δ |
| Example55 | 3.0 | B | 1205 | 2.11 | ◯ | Δ |
| Example56 | 3.0 | B | 1210 | 2.04 | ◯ | Δ |
| Example57 | 3.0 | B | 1204 | 2.06 | ◯ | Δ |
| Example58 | 3.0 | B | 1212 | 2.11 | ◯ | Δ |
| Example59 | 3.0 | B | 1206 | 2.14 | ◯ | Δ |
| Example60 | 3.0 | B | 1208 | 2.11 | ◯ | Δ |

TABLE 7

| | | | Capac- | | | |
|---|---|---|---|---|---|---|
| | R | | itance | Voltage | Judgment | |
| | (mm) | Type | (mF) | (V) | Capacitance | Voltage |
| Comparative | 0 | A | 1205 | 1.75 | ◯ | X |
| Example1 | | | | | | |
| Comparative | 0 | A | 1208 | 1.69 | ◯ | X |
| Example2 | | | | | | |
| Comparative | 0 | A | 1200 | 1.72 | ◯ | X |
| Example3 | | | | | | |
| Comparative | 0 | A | 1210 | 1.83 | ◯ | X |
| Example4 | | | | | | |
| Comparative | 0 | A | 1204 | 1.77 | ◯ | X |
| Example5 | | | | | | |
| Comparative | 0 | A | 1203 | 1.83 | ◯ | X |
| Example6 | | | | | | |
| Comparative | 0 | A | 1208 | 1.86 | ◯ | X |
| Example7 | | | | | | |
| Comparative | 0 | A | 1204 | 1.89 | ◯ | X |
| Example8 | | | | | | |
| Comparative | 0 | A | 1210 | 1.64 | ◯ | X |
| Example9 | | | | | | |
| Comparative | 0 | A | 1205 | 1.68 | ◯ | X |
| Example10 | | | | | | |

TABLE 8

| | | | Capacitance | Voltage | Judgment | |
|---|---|---|---|---|---|---|
| | R (mm) | Type | (mF) | (V) | Capacitance | Voltage |
| Example61 | 0.2 | A | 1205 | 2.23 | ◯ | ◯ |
| Example62 | 0.2 | A | 1207 | 2.20 | ◯ | ◯ |
| Example63 | 0.2 | A | 1208 | 2.21 | ◯ | ◯ |
| Example64 | 0.2 | A | 1210 | 2.21 | ◯ | ◯ |
| Example65 | 0.2 | A | 1214 | 2.22 | ◯ | ◯ |
| Example66 | 0.2 | A | 1211 | 2.20 | ◯ | ◯ |
| Example67 | 0.2 | A | 1212 | 2.21 | ◯ | ◯ |
| Example68 | 0.2 | A | 1208 | 2.22 | ◯ | ◯ |
| Example69 | 0.2 | A | 1207 | 2.21 | ◯ | ◯ |
| Example70 | 0.2 | A | 1214 | 2.21 | ◯ | ◯ |

The experiment results with samples wherein the electrode width W is 24 mm are as described below. The judgment of capacitance was made according to the following criteria: a sample with the capacitance of not less than 2200 mF was defined as nondefective (◯) and a sample with the capacitance of not less than 2100 mF as acceptable (Δ). W/3=8 mm.

TABLE 9

| | | | Capac- | | | |
|---|---|---|---|---|---|---|
| | R | | itance | Voltage | Judgment | |
| | (mm) | Type | (mF) | (V) | Capacitance | Voltage |
| Example71 | 7.8 | A | 2220 | 2.28 | ◯ | ◯ |
| Example72 | 7.8 | A | 2228 | 2.29 | ◯ | ◯ |
| Example73 | 7.8 | A | 2217 | 2.25 | ◯ | ◯ |
| Example74 | 7.8 | A | 2215 | 2.28 | ◯ | ◯ |
| Example75 | 7.8 | A | 2224 | 2.27 | ◯ | ◯ |
| Example76 | 7.8 | A | 2222 | 2.26 | ◯ | ◯ |
| Example77 | 7.8 | A | 2217 | 2.28 | ◯ | ◯ |
| Example78 | 7.8 | A | 2219 | 2.30 | ◯ | ◯ |
| Example79 | 7.8 | A | 2223 | 2.27 | ◯ | ◯ |
| Example80 | 7.8 | A | 2216 | 2.26 | ◯ | ◯ |

TABLE 10

| | | | Capac- | | | |
|---|---|---|---|---|---|---|
| | R | | itance | Voltage | Judgment | |
| | (mm) | Type | (mF) | (V) | Capacitance | Voltage |
| Example8l | 8.2 | A | 2116 | 2.24 | Δ | ◯ |
| Example82 | 8.2 | A | 2120 | 2.25 | Δ | ◯ |
| Example83 | 8.2 | A | 2117 | 2.23 | Δ | ◯ |
| Example84 | 8.2 | A | 2126 | 2.22 | Δ | ◯ |
| Example85 | 8.2 | A | 2124 | 2.24 | Δ | ◯ |
| Example86 | 8.2 | A | 2119 | 2.23 | Δ | ◯ |
| Example87 | 8.2 | A | 2127 | 2.22 | Δ | ◯ |
| Example88 | 8.2 | A | 2124 | 2.24 | Δ | ◯ |
| Example89 | 8.2 | A | 2125 | 2.23 | Δ | ◯ |
| Example90 | 8.2 | A | 2118 | 2.22 | Δ | ◯ |

From the above experiment results, the voltage holding property was better in the cases where the outside end of the anode electrode A was provided with the curvature as in Examples 1 to 60, than in Comparative Examples 1 to 10. Since W=12.5 mm, W/3=4.17 mm. When R exceeds 4.17 (mm) (Example 41 to Example 50), the property of capacitance comes to degrade. This is conceivably because when R exceeds W/3, the end of the electrode loses linearity to cause disadvantages such as positional deviation of the electrode and decrease in the opposed electrode area, and these disadvantages caused the degradation of the capacitance property. When the value of R becomes smaller than 0.2 (mm) (Example 31 to Example 40), the corners become sharp, so as to cause the electric leakage. It was thus confirmed that when the relation of 0.2 (mm)≦R (mm)≦W (mm)/3 is satisfied, the voltage holding property becomes very good (Example 1 to Example 30 and Example 51 to Example 70). With the samples having the electrode width W changed, the good results were also obtained in the cases where the curvature was provided as described above (Example 71 to Example 90), and the better results were obtained when the value of R satisfied the above relation (Example 71 to Example 80).

The electrochemical device of the second category will be described below.

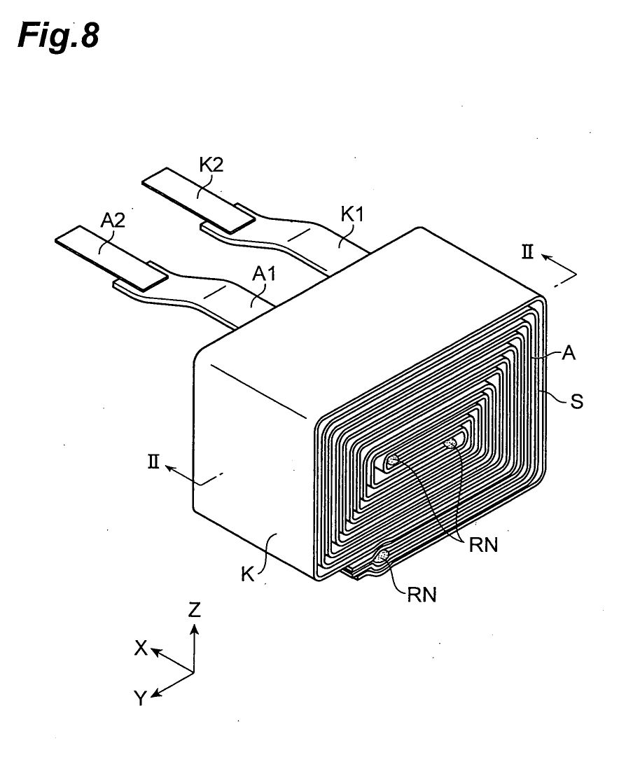

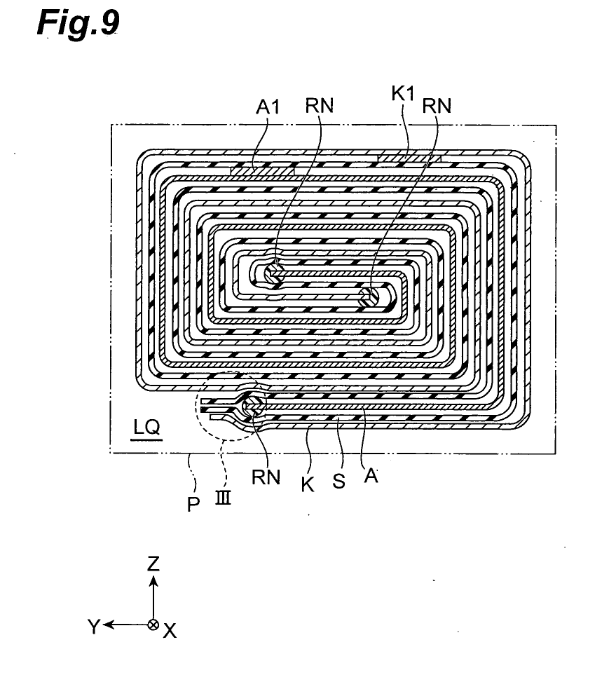

FIG. 8 is a perspective view of the wound electrochemical device (without illustration of an outer package) according to an embodiment, and FIG. 9 is a cross-sectional view of the wound electrochemical device shown in FIG. 8, along a line and in a direction of arrows II-II. In the drawings there is an XYZ three-dimensional orthogonal coordinate system shown.

This wound electrochemical device has a beltlike anode electrode A, a beltlike cathode electrode K, and a beltlike separator S in an outer package P (cf. FIG. 9). The separator S is interposed between the anode electrode A and the cathode electrode K and these are wound around the X-axis. The X-axis is coincident with width directions of the beltlike anode electrode A, cathode electrode K, and separator S. The Z-axis direction in FIG. 9 is a thickness direction of portions extending along the Y-axis direction, of the anode electrode A, cathode electrode K, and separator S, but is a length direction of portions thereof extending along the Z-axis direction.

The anode electrode A, cathode electrode K, and separator S are wound in one direction. When the winding start position is defined at one ends of the anode electrode A and cathode electrode K, the one ends are located near the center of the electrochemical device. When the winding end position is defined at the other ends of the anode electrode A and cathode electrode K, the other ends are located in outside layers of the electrochemical device.

An electrolytic solution LQ is retained inside the outer package P as needed. The electrolytic solution LQ to be used herein is one obtained by dissolving an electrolyte in an organic solvent. The electrolyte used generally is a quaternary ammonium salt such as tetraethylammonium tetrafluoroborate (TEA⁺BF₄⁻: (which will be referred to hereinafter as TEA-BF4)) or triethyl monomethyl ammonium tetrafluoroborate (TEMA⁺BF₄⁻). These electrolytes may be used singly or in combination of two or more. The organic solvent applicable herein is one of the known solvents. Preferred examples of the organic solvent include propylene carbonate, ethylene carbonate, diethyl carbonate, and so on. These may be used singly or in a mixture of two or more at an optional ratio.

As described above, this wound electrochemical device is a wound electrochemical device configured by superimposing one end of the beltlike anode electrode A and one end of the beltlike cathode electrode K on each other with the separator S in between so as to make their respective width directions (X-axis) coincident with each other, defining the width directions as an axis (X-axis), and winding the anode electrode A and the cathode electrode K with the separator S in between around the axis in the same direction.

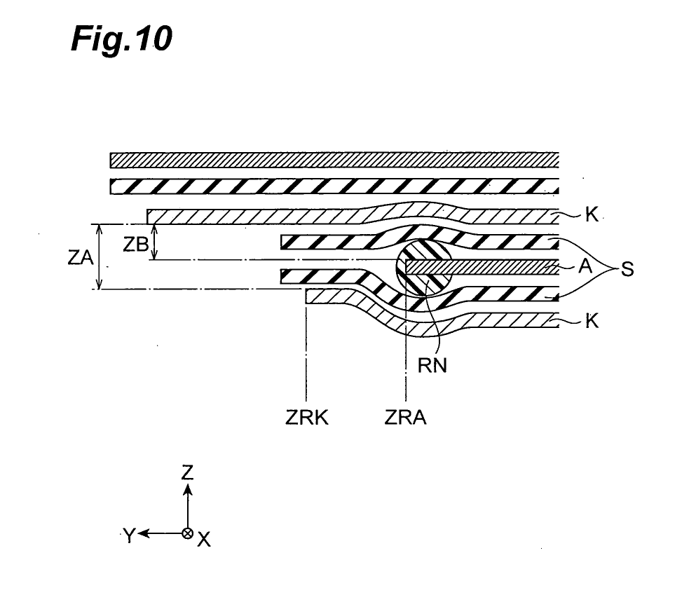

FIG. 10 is an enlarged cross-sectional view of region III shown in FIG. 9, and shows the region near the winding end positions of the anode electrode A and the cathode electrode K.

Near the winding end positions, the anode electrode A and the cathode electrode K have their respective other ends. Let ZRA be the position of the other end along the length direction of the anode electrode A, and ZRK be the position of the other end along the length direction of the cathode electrode K. The distance of separation along the length direction (Y-axis) between these positions ZRA and ZRK is preferably as long as possible. The reason is that an electric current is likely to leak at the ends and if those locations are close to each other, an electric current will actually leak significantly.

ZA refers to a minimum distance of separation in the thickness direction (Z-axis direction) between the electrode of one polarity (cathode electrode K) and the electrode of the same polarity (cathode electrode A) at the position of the other end (ZRK). Furthermore, ZB refers to a minimum distance of separation in the thickness direction (Z-axis direction) between the electrode of one polarity (anode electrode A) and the electrode of the other polarity (cathode electrode K) at the position of the other end (ZRA). Since the cathode electrode K is opposed through two or more layers of separator S and to the cathode electrode K of the same polarity, an electric leak is unlikely to occur between these. On the other hand, since the other end of the anode electrode A is opposed to the cathode electrode K of the different polarity through one layer of separator S, electric coupling is likely to occur between these and an electric leak can occur (ZA>ZB).

Then, in order to suppress the electric leakage at the other end of the anode electrode A, resin layers RN are bonded to the respective corners of the terminal end of the anode electrode A, so as to increase the effective distance of separation to the cathode electrode K. Namely, the resin layers RN are bonded to both of the front surface and back surface of the anode electrode. It is possible to adopt a configuration wherein the resin layers RN become solidified in a state in which they are bonded only to the anode electrode A and they are not bonded to the separator S adjacent thereto, but it is also possible herein to adopt a configuration wherein after solidification of the resin layers RN, thermal press and cooling steps are carried out to implement re-melting and solidification so as to make the resin layers also bonded to the adjacent separator S.

The resin layers RN bonded to the corners are preferably bonded to the adjacent separator S as well, and in this case, the resin layers can secure the electrode and the separator. Furthermore, the resin layers RN preferably contain polyvinylidene fluoride (PVDF). When polyvinylidene fluoride is used, the resin layers have high heat resistance and provide an effect to avoid deterioration of the resin layers even if the electrochemical device becomes hot during operation thereof. The active material layers of the electrode use a binder, and when it contains polyvinylidene fluoride, affinity between the resin layers and the electrode becomes enhanced, providing an advantage of improvement in bond strength.

The resin layers may also be bonded to the corners on the cathode electrode K side. The anode electrode A and the cathode electrode K are replaceable with each other in terms of position and shape, and the addition of the adhesive layers to the anode electrode A is also applicable to the cathode electrode. Such adhesive layers RN may also be bonded similarly to the respective corners of the electrodes at the winding start position (cf. FIG. 8).

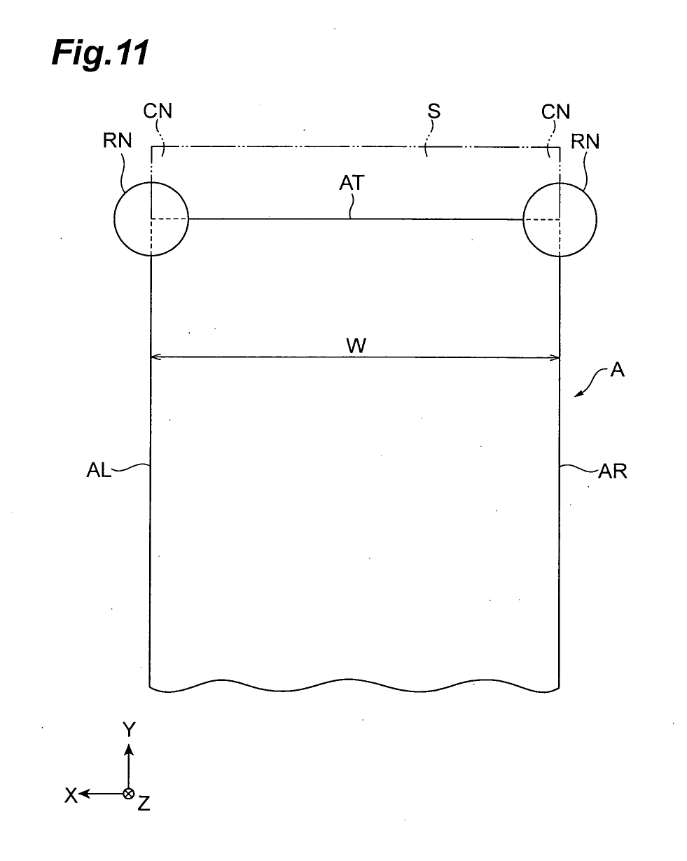

FIG. 11 is a plan view of a tip portion of the beltlike anode electrode A.

The outer edge of the corners of the other end of the anode electrode A consists of a line segment AT as a leading end, and line segments AL and AR extending at right angles from the both ends of the line segment AT, when viewed from a direction parallel to the thickness direction (Z-axis) thereof. The outer edge of the corners of the other end of the other, the cathode electrode K, is not located on a straight line passing the outer edge of the foregoing corners (the line segments AT, AL, AR located inside the resin layers RN) and being parallel to the thickness direction (Z-axis) of the corners (in other words, ZRA and ZRK do not coincide in FIG. 9).

In this wound electrochemical device, the corners at the winding end position of the anode electrode A (the corners of the other end thereof) are provided with the adhesive layers RN, and in this case, we found that the voltage holding property was remarkably improved. A conceivable reason for it is that the electric leakage was suppressed by increasing the distance between the electrodes by the thickness of the resin layers. Furthermore, this position of the anode electrode A is different from the position of the corners in the cathode electrode K opposed thereto (it is opposed to a flat portion of the cathode electrode), and this also provides an advantage of producing no leak current between the corners of the different polarities.

The thickness of the resin layers is preferably not less than 10 μm and not more than 100 μm. In this case, the voltage holding property becomes very good.

The length of the separator S is larger than that of the anode electrode A and the tip portion of the separator S is projecting forward (in the positive direction of the Y-axis) from the side AT located at the leading end of the anode electrode A. A pair of sides AL, AR perpendicular to the width direction of the anode electrode A are parallel and these are 90° different in extending direction from the side AT at the leading end. Therefore, this configuration can prevent a leak current from flowing around the separator S between the anode electrode A and the cathode electrode K opposed thereto. Concerning the outer edge shape of the anode electrode A, the pair of sides AL and AR extending left and right are parallel to each other, and the side AT is perpendicular to them. The tip portion of the separator S consists of two sides parallel to the length direction, and a side at the leading end perpendicular thereto, and has two corners CN. These corners CN are right-angled.

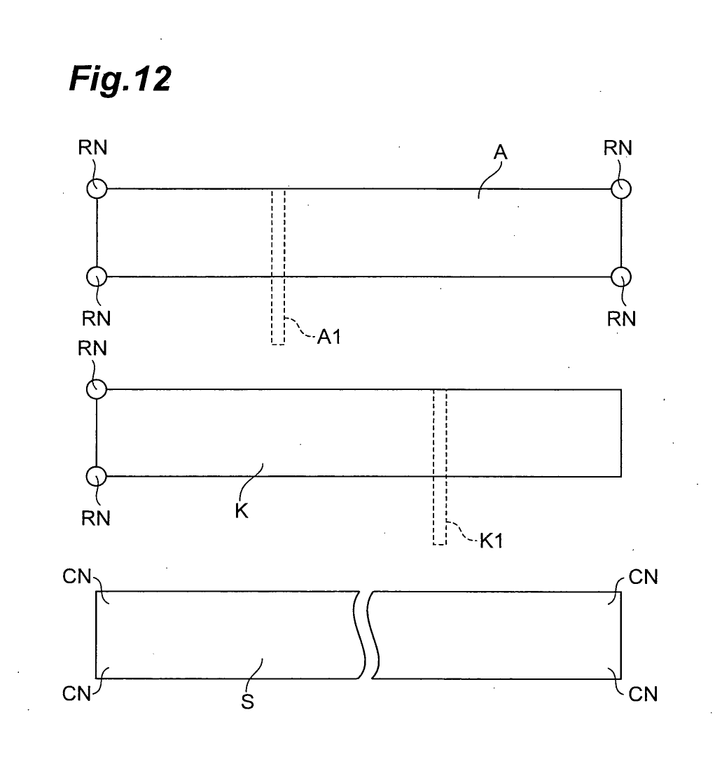

FIG. 12 is a plan view of the beltlike electrodes and separator.

The anode electrode A is the beltlike electrode and has four corners, and in the present embodiment all the corners are provided with the resin layers RN. A tab (lead) Al is attached at the position of about ⅔ of the length from the right end of the anode electrode A. Similarly, the cathode electrode K is the beltlike electrode and has four corners, and in the present embodiment two corners are provided with the resin layers RN and the remaining two corners are not provided with the resin layers. This is because it is considered that even if an electric field is concentrated at such portions of the cathode electrode, the electric leakage is unlikely to occur because the distance is long to the anode electrode adjacent in the thickness direction. A tab (lead) K1 is attached at the position of about ⅔ of the length from the left end of the cathode electrode K. The separator S is not provided with resin layers at its ends, and thus the four corners all are right-angled.

A method for manufacturing the wound electrochemical device will be described below.

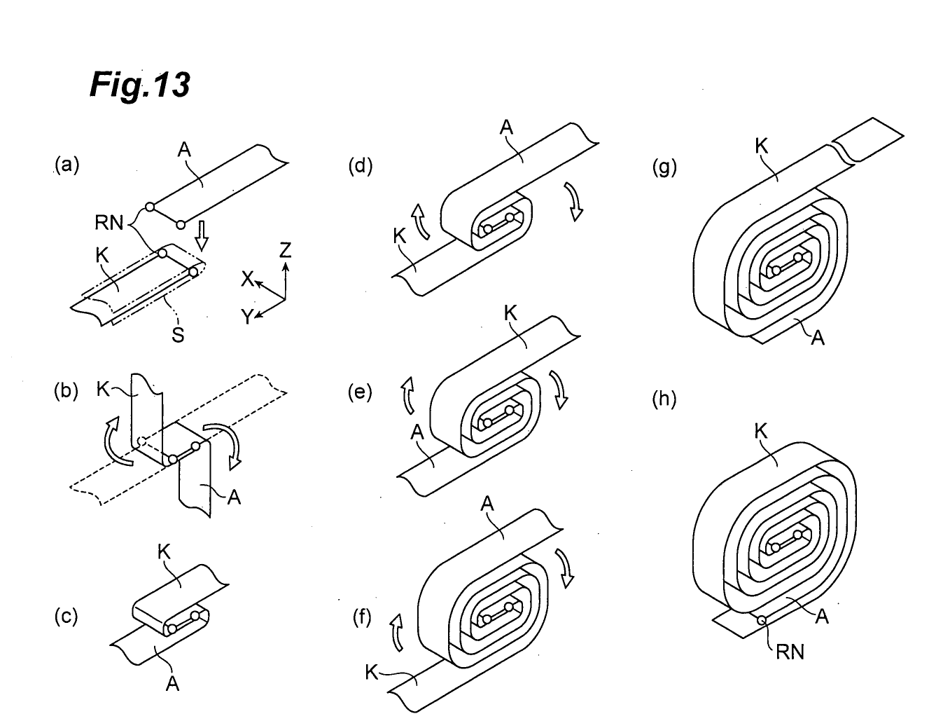

FIG. 13 is an explanatory drawing for explaining the method for manufacturing the wound electrochemical device.

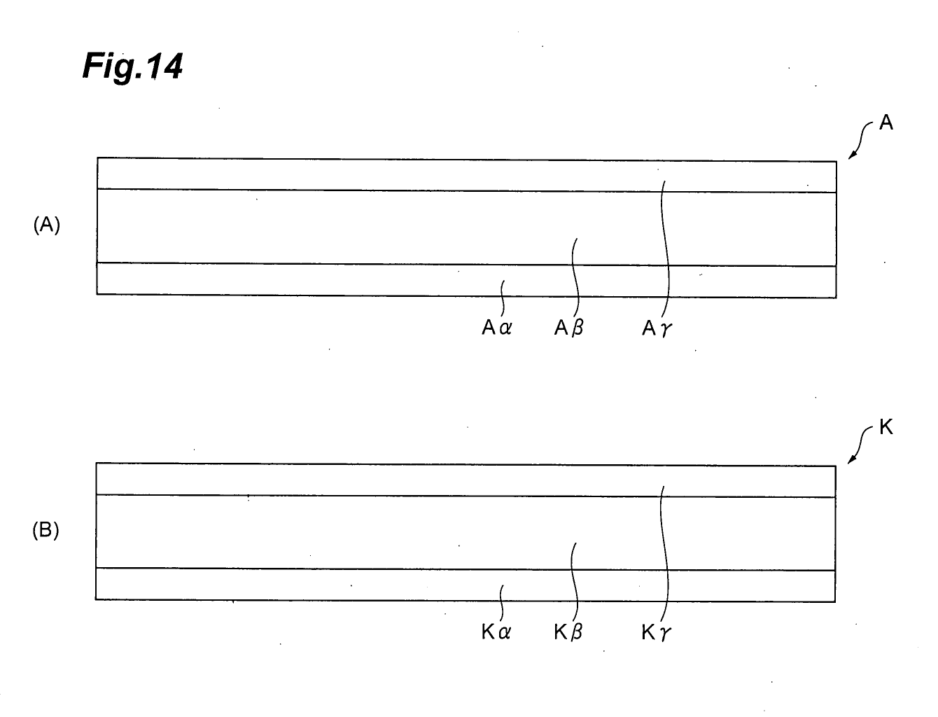

In the manufacturing method of the wound electrochemical device, the first step is to prepare the beltlike anode electrode A and the beltlike cathode electrode K. Specific structures of the anode electrode A and the cathode electrode K are, for example, as shown in FIG. 14. The next step is, as shown in FIG. 13(a), to superimpose one end of the beltlike anode electrode A and one end of the beltlike cathode electrode K on each other with the separator S in between so as to make their respective width directions coincident with each other. The separator S is folded into two and then the cathode electrode K is inserted into between the folded portions. Although the separator S is still present in the subsequent steps, the illustration of the separator S is omitted in the drawing after FIG. 13(b), for clarity of the description on the drawing. In the superposition of the one ends, because the anode electrode A and the cathode electrode K are provided similarly with the resin layers RN at their one ends, the electric leakage is also prevented at such positions.

Next, as shown in FIG. 13(b) to FIG. 13(h), the anode electrode A and the cathode electrode K are bent in directions of arrows. Namely, as the width directions (X-axis) of these are defined as an axis, the anode electrode A and cathode electrode K are wound with the separator S in between around the axis in the same direction. The lengths of the anode electrode A and cathode electrode are so set that at the final stage after they are wound as shown in the same drawing, the outer edge (position ZRK) of the corners of the other end of one of the anode electrode A and the cathode electrode K is not located on a straight line (position ZRA) passing the outer edge of the corners of the other end of the other and being parallel to the thickness direction thereof, as shown in FIG. 10.

Before the winding step, as shown in FIG. 12, the resin layers are bonded to the corners of the other end of at least one of the anode electrode A and the cathode electrode K. Namely, this manufacturing method includes a step of bonding the resin layers RN to the corners. In this case, it becomes feasible to suppress burrs at the corners. Furthermore, the separator becomes less likely to be broken by the corners, and even if the separator is broken, the resin layers provide an effect to prevent a short. This step preferably includes a step of applying a solution obtained by dissolving a resin material (PVDF) in a solvent (N-methylpyrrolidone (NMP)), onto the corners at room temperature, and a step of drying the solution at 110° C. after the application. In this case, the method provides an effect to facilitate formation of film for prevention of a short. The resin layers RN can be applied by keeping the solution in a container and dipping the corners into the solution, and the thickness thereof can be changed by adjusting a concentration of the solution.

When the above-described manufacturing method is applied, the electrochemical device can be manufactured with remarkable improvement in the voltage holding property.

FIG. 14 is side views showing multilayer structures of the anode electrode and cathode electrode.

The anode electrode A has a beltlike collector Aβ, and positive-electrode active material layers Aα, Aγ formed on the front surface and back surface of the collector Aβ. The cathode electrode K has a beltlike collector Kβ, and negative-electrode active material layers Kα, Kγ formed on the front surface and back surface of the collector Kβ. The collectors are generally made of copper or aluminum and the thickness thereof is, for example, about 10-50 μm. The collectors Aβ, Kβ are equipped with respective tab electrodes A1, K1 as shown in FIG. 8 and leads A2, K2 are connected to respective tips of the tab electrodes A1, K1. The leads A2, K2 are exposed in part to the outside of the outer package P (cf. FIG. 10).

The positive-electrode active material layers Aα, Aγ and the negative-electrode active material layers Kα, Kγ contain an active material and a binder and preferably contain an electroconductive aid.

The active material may be one of various porous materials with electron conductivity, e.g., carbon materials such as natural graphite, synthetic graphite, mesocarbon microbeads, mesocarbon fiber (MCF), coke, glassy carbon, a baked product of an organic compound, and so on. There are no particular restrictions on the binder as long as it can fix the foregoing active material and, preferably, the electroconductive aid to the collectors; it can be selected from a variety of binding agents.

Examples of the binder include fluorine resins such as polyvinylidene fluoride (PVDF) and polytetrafluoroethylene (PTFE), mixtures of styrene-butadiene rubber (SBR) and water-soluble polymers (carboxymethyl cellulose, polyvinyl alcohol, sodium polyacrylate, dextrin, gluten, etc.), and so on.

The electroconductive aid is a material that is added in order to enhance the electron conductivity of the positive-electrode active material layers and the negative-electrode active material layers. Examples of the electroconductive aid include carbon materials such as carbon black and acetylene black, fine powders of metal such as copper, nickel, stainless steel, or iron, mixtures of the carbon materials and the fine metal powders, and electroconductive oxides such as ITO.

The thickness of the positive-electrode active material layers Aα, Aγ and the negative-electrode active material layers Kα, Kγ is, for example, about 1-200 μm. The positive-electrode active material layers and the negative-electrode active material layers are formed on the respective collectors so as to avoid the tab for connection to the lead. The positive-electrode active material layers and the negative-electrode active material layers can be made by one of the known methods.

The separator S is an element for electrically isolating the anode electrode A and the cathode electrode K from each other, and is an electrically insulating porous body. There are no particular restrictions on the separator S and the separator S can be selected from a variety of separator materials. For example, the electrically insulating porous body can be a single-layer body or multilayer body of film comprised of polyethylene, polypropylene, or polyolefin, a stretched film of a mixture of the foregoing resins, or a nonwoven fabric of fiber comprised of at least one constituent material selected from the group consisting of cellulose, polyester, and polypropylene. The thickness of the separator S is, for example, about 5-50 μm.

Next, experiments to produce the above-described electrochemical device of the second category experimentally were conducted.

### Experiment Examples

The wound electrochemical device (EDLC) was produced in the following manner. The number of turns of the anode electrode was 6. Common conditions are as described below. The resin layers RN were provided at the locations in FIG. 12. The activated carbon used as the active material was activated carbon (RP-20) available from KURARAY CHEMICAL CO., LTD.
Anode electrode
   dimensions:
      width W=12.5 mm
      thickness=57 μm
      length=95 mm
   materials;
      collector: aluminum
      active material: activated carbon
Cathode electrode
   dimensions:
      width W=12.5 mm
      thickness=57 μm
      length=117 μm
   materials:
      collector: aluminum
      active material: activated carbon
Separator
   dimensions:
      width W=14.5 mm
      thickness=30 μm
      length=197 μm
   material:
      cellulose
Electrolytic solution
   material: TEA-BF4
Tab material: aluminum
Lead material: aluminum
Deviation between electrodes (distance between position ZRA and position ZRK) 5 mm
Material of resin layers RN: polyvinylidene fluoride

### (Evaluations and Results)

The evaluations and results of Examples and Comparative Examples of the second category will be presented below.

The evaluations were carried out as follows: at room temperature, the voltage of 2.5 V was applied between the anode electrode and the cathode electrode of the electrochemical device, the device was charged for one hour, a charger was then taken out, the device was left for two hours, and the impedance (mΩ) and voltage (V) between these electrodes were measured. The tables below provide the application thickness of resin, impedance (mΩ), measured voltage (V), and judgment results of these impedance and voltage. The judgment of impedance was made according to the following criteria: a sample with the impedance of not more than 50 mΩ was defined as nondefective (◯) and a sample with the impedance of not more than 60 mΩ as acceptable (Δ). The judgment of voltage was made according to the following criteria: a sample with the voltage of not less than 22 V was defined as nondefective (◯), a sample with the voltage of not less than 2.0 V as acceptable (Δ), and a sample with the voltage of less than 2.0 V as defective (×). It is noted concerning the experiments below that the same results must be obtained even with replacement of the anode electrode and the cathode electrode with each other.

TABLE 1

| | Application | | | | |
|---|---|---|---|---|---|
| | thickness | Impedance | Voltage | Judgment | |
| | of resin | (mΩ) | (V) | Impedance | Voltage |
| Example1 | 50 μm | 42 | 2.31 | ◯ | ◯ |
| Example2 | 50 μm | 42 | 2.37 | ◯ | ◯ |
| Example3 | 50 μm | 40 | 2.33 | ◯ | ◯ |
| Example4 | 50 μm | 39 | 2.34 | ◯ | ◯ |
| Example5 | 50 μm | 41 | 2.32 | ◯ | ◯ |
| Example6 | 50 μm | 40 | 2.34 | ◯ | ◯ |
| Example7 | 50 μm | 38 | 2.37 | ◯ | ◯ |
| Example8 | 50 μm | 38 | 2.37 | ◯ | ◯ |
| Example9 | 50 μm | 41 | 2.32 | ◯ | ◯ |
| Example10 | 50 μm | 40 | 2.32 | ◯ | ◯ |

TABLE 2

| | Application | | | | |
|---|---|---|---|---|---|
| | thickness | Impedance | Voltage | Judgment | |
| | of resin | (mΩ) | (V) | Impedance | Voltage |
| Example11 | 15 μm | 42 | 2.22 | ◯ | ◯ |
| Example12 | 15 μm | 42 | 2.22 | ◯ | ◯ |
| Example13 | 15 μm | 40 | 2.23 | ◯ | ◯ |
| Example14 | 15 μm | 41 | 2.22 | ◯ | ◯ |
| Example15 | 15 μm | 39 | 2.24 | ◯ | ◯ |
| Example16 | 15 μm | 40 | 2.21 | ◯ | ◯ |
| Example17 | 15 μm | 39 | 2.20 | ◯ | ◯ |
| Example18 | 15 μm | 41 | 2.22 | ◯ | ◯ |
| Example19 | 15 μm | 42 | 2.20 | ◯ | ◯ |
| Example20 | 15 μm | 40 | 2.26 | ◯ | ◯ |

TABLE 3

| | Application | | | | |
|---|---|---|---|---|---|
| | thickness | Impedance | Voltage | Judgment | |
| | of resin | (mΩ) | (V) | Impedance | Voltage |
| Example21 | 95 μm | 50 | 2.31 | ◯ | ◯ |
| Example22 | 95 μm | 49 | 2.36 | ◯ | ◯ |
| Example23 | 95 μm | 48 | 2.31 | ◯ | ◯ |
| Example24 | 95 μm | 49 | 2.31 | ◯ | ◯ |
| Example25 | 95 μm | 47 | 2.31 | ◯ | ◯ |
| Example26 | 95 μm | 48 | 2.35 | ◯ | ◯ |
| Example27 | 95 μm | 50 | 2.31 | ◯ | ◯ |
| Example28 | 95 μm | 48 | 2.37 | ◯ | ◯ |
| Example29 | 95 μm | 48 | 2.33 | ◯ | ◯ |
| Example30 | 95 μm | 47 | 2.33 | ◯ | ◯ |

TABLE 4

| | Application | | | | |
|---|---|---|---|---|---|
| | thickness | Impedance | Voltage | Judgment | |
| | of resin | (mΩ) | (V) | Impedance | Voltage |
| Example31 | 5 μm | 40 | 2.02 | ◯ | Δ |
| Example32 | 5 μm | 42 | 2.09 | ◯ | Δ |
| Example33 | 5 μm | 42 | 2.10 | ◯ | Δ |
| Example34 | 5 μm | 40 | 2.11 | ◯ | Δ |
| Example35 | 5 μm | 38 | 2.13 | ◯ | Δ |
| Example36 | 5 μm | 40 | 2.12 | ◯ | Δ |
| Example37 | 5 μm | 41 | 2.01 | ◯ | Δ |
| Example38 | 5 μm | 42 | 2.03 | ◯ | Δ |
| Example39 | 5 μm | 42 | 2.01 | ◯ | Δ |
| Example40 | 5 μm | 41 | 2.00 | ◯ | Δ |

TABLE 5

| | Application | | | | |
|---|---|---|---|---|---|
| | thickness | Impedance | Voltage | Judgment | |
| | of resin | (mΩ) | (V) | Impedance | Voltage |
| Example41 | 105 μm | 57 | 2.34 | Δ | ◯ |
| Example42 | 105 μm | 60 | 2.32 | Δ | ◯ |
| Example43 | 105 μm | 57 | 2.35 | Δ | ◯ |
| Example44 | 105 μm | 58 | 2.34 | Δ | ◯ |
| Example45 | 105 μm | 58 | 2.33 | Δ | ◯ |
| Example46 | 105 μm | 59 | 2.33 | Δ | ◯ |
| Example47 | 105 μm | 56 | 2.30 | Δ | ◯ |
| Example48 | 105 μm | 60 | 2.30 | Δ | ◯ |
| Example49 | 105 μm | 57 | 2.32 | Δ | ◯ |
| Example50 | 105 μm | 58 | 2.31 | Δ | ◯ |

TABLE 6

| | Application | | | | |
|---|---|---|---|---|---|
| | thickness | Impedance | Voltage | Judgment | |
| | of resin | (mΩ) | (V) | Impedance | Voltage |
| Example51 | 10 μm | 40 | 2.20 | ◯ | ◯ |
| Example52 | 10 μm | 42 | 2.21 | ◯ | ◯ |
| Example53 | 10 μm | 42 | 2.20 | ◯ | ◯ |
| Example54 | 10 μm | 41 | 2.20 | ◯ | ◯ |
| Example55 | 10 μm | 40 | 2.21 | ◯ | ◯ |
| Example56 | 100 μm | 50 | 2.32 | ◯ | ◯ |
| Example57 | 100 μm | 50 | 2.31 | ◯ | ◯ |
| Example58 | 100 μm | 49 | | | ◯ |
| Example59 | 100 μm | 50 | 2.32 | ◯ | ◯ |
| Example60 | 100 μm | 50 | 2.30 | ◯ | ◯ |

TABLE 7

| | Application | | | | |
|---|---|---|---|---|---|
| | thickness | Impedance | Voltage | Judgment | |
| | of resin | (mΩ) | (V) | Impedance | Voltage |
| Comparative | 0 μm | 42 | 1.85 | ◯ | X |
| Example1 | | | | | |
| Comparative | 0 μm | 41 | 1.68 | ◯ | X |
| Example2 | | | | | |
| Comparative | 0 μm | 42 | 1.77 | ◯ | X |
| Example3 | | | | | |
| Comparative | 0 μm | 42 | 1.69 | ◯ | X |
| Example4 | | | | | |
| Comparative | 0 μm | 41 | 1.89 | ◯ | X |
| Example5 | | | | | |
| Comparative | 0 μm | 39 | 1.91 | ◯ | X |
| Example6 | | | | | |
| Comparative | 0 μm | 42 | 1.86 | ◯ | X |
| Example7 | | | | | |
| Comparative | 0 μm | 43 | 1.78 | ◯ | X |
| Example8 | | | | | |
| Comparative | 0 μm | 42 | 1.85 | ◯ | X |
| Example9 | | | | | |
| Comparative | 0 μm | 42 | 1.90 | ◯ | X |
| Example10 | | | | | |

From the above experiment results, the voltage holding property was better in the cases where the resin layers RN were provided at the outside end of the anode electrode A as in Examples 1 to 60, than in Comparative Examples 1 to 10. When the thickness of the resin layers RN was in the range of not less than 10 μm and not more than 100 μm (in the cases of Example 1 to Example 30 and Examples 51 to 60), the samples were found to be extremely excellent in the judgment result of impedance or voltage, when compared with the examples off this range (Example 31 to Example 50).

What is claimed is:

1. A wound electrochemical device configured by superimposing one end of a beltlike anode electrode and one end of a beltlike cathode electrode on each other with a separator in between so as to make their respective width directions coincident with each other, defining the width directions as an axis, and winding the anode electrode and the cathode electrode with the separator in between around the axis in an identical direction,
wherein an outer edge of a corner of the other end of at least one of the anode electrode and the cathode electrode consists of an arcuate curve when viewed from a direction parallel to a thickness direction thereof, and
wherein an outer edge of a corner of the other end of the other of the anode electrode and the cathode electrode is not located on a straight line passing the outer edge of the corner of the other end of the at least one and being parallel to the thickness direction.

2. The wound electrochemical device according to claim 1, satisfying the following relational expression: 0.2 (mm)≦R (mm)≦W (mm)/3, where W (mm) is a width of the electrode providing the arcuate curve and R (mm) a radius of curvature of said curve.

3. A method for manufacturing a wound electrochemical device, comprising:
a step of preparing a beltlike anode electrode and a beltlike cathode electrode;
a step of superimposing one end of the beltlike anode electrode and one end of the beltlike cathode electrode on each other with a separator in between so as to make their respective width directions coincident with each other; and
a step of defining the width directions as an axis and winding the anode electrode and the cathode electrode with the separator in between around the axis in an identical direction,
the method further comprising a step of processing a corner of the other end of at least one of the anode electrode and the cathode electrodes, said step comprising such processing that an outer edge of the corner consists of an arcuate curve when viewed from a direction parallel to a thickness direction thereof,
the method comprising such setting that an outer edge of a corner of the other end of the other of the anode electrode and the cathode electrode is not located on a straight line passing the outer edge of the corner of the other end of the at least one and being parallel to the thickness direction.

4. The method according to claim 3, wherein in the step of processing the corner, the corner formed by said step satisfies the following relational expression: 0.2 (mm)≦R (mm)≦W (mm)/3, where W (mm) is a width of the electrode providing the arcuate curve and R (mm) a radius of curvature of said curve.

5. A wound electrochemical device configured by superimposing one end of a beltlike anode electrode and one end of a beltlike cathode electrode on each other with a separator in between so as to make their respective width directions coincident with each other, defining the width directions as an axis, and winding the anode electrode and the cathode electrode with the separator in between around the ads in an identical direction,
wherein a resin layer is bonded to a corner of the other end of at least one of the anode electrode and the cathode electrode, and
wherein an outer edge of a corner of the other end of the other of the anode electrode and the cathode electrode is not located on a straight line passing an outer edge of the corner of the other end of the at least one and being parallel to a thickness direction thereof.

6. The wound electrochemical device according to claim 5, wherein a thickness of the resin layer is not less than 10 μm and not more than 100 μm.

7. The wound electrochemical device according to claim 5, wherein the resin layer bonded to the corner is also bonded to the separator adjacent thereto.

8. The wound electrochemical device according to claim 5, wherein the resin layer contains polyvinylidene fluoride.

9. A method for manufacturing a wound electrochemical device, comprising:
a step of preparing a beltlike anode electrode and a beltlike cathode electrode;
a step of superimposing one end of the beltlike anode electrode and one end of the beltlike cathode electrode on each other with a separator in between so as to make their respective width directions coincident with each other; and
a step of defining the width directions as an axis and winding the anode electrode and the cathode electrode with the separator in between around the axis in an identical direction,
the method further comprising a step of bonding a resin layer to a corner of the other end of at least one of the anode electrode and the cathode electrode,
the method comprising such setting that an outer edge of a corner of the other end of the other of the anode electrode and the cathode electrode is not located on a straight line passing an outer edge of the corner of the other end of the at least one and being parallel to a thickness direction thereof.

10. The method according to claim 9, wherein a thickness of the resin layer is not less than 10 μm and not more than 100 μm.

11. The method according to claim 9, wherein the step of bonding the resin layer to the corner comprises:
a step of applying a solution obtained by dissolving a resin material in a solvent, onto the corner; and
a step of drying the solution after applied.

12. The method according to claim 11, wherein the resin material contains polyvinylidene fluoride, and wherein the solvent contains N-methylpyrrolidone.
